(19) United States
(12) Patent Application Publication
(10) Pub. No.: US 2015/0195086 A1
(43) Pub. Date: Jul. 9, 2015

(54) MEDIATED ENCRYPTION POLICY FRAMEWORK FOR USER-TRANSPARENT METHOD-AGNOSTIC DATA PROTECTION

(71) Applicant: Core Business IT, LLC, Hanahan, SC (US)

(72) Inventor: Evan Davison, Hanahan, SC (US)

(73) Assignee: Core Business IT, LLC, Hanahan, SC (US)

(21) Appl. No.: 14/589,978

(22) Filed: Jan. 5, 2015

Related U.S. Application Data
(60) Provisional application No. 61/923,712, filed on Jan. 5, 2014.

(51) Int. Cl. H04L 9/08; H04L 9/14

(52) U.S. Cl. CPC H04L 9/0822; H04L 9/14; H04L 2209/24

(57) ABSTRACT

With the invention, rather than a sender encrypting the data directly to the key of the intended recipient, the sender instead encrypts the data to a policy decision point (residing, for instance, on a server), and instructs the server as to the policy under which it is to be decrypted (for instance, when someone with certain responsibilities asks for it, when a date has been reached, etc.).

### CROSS-REFERENCE TO RELATED APPLICATIONS

This application claims priority to U.S. Provisional Patent Application Ser. No. 61/923,712 entitled “Mediated Encryption Policy Framework For User-Transparent Method-Agnostic Data Protection,” filed on Jan. 5, 2013, the contents of which are hereby incorporated by reference in its entirety.

### FIELD OF THE INVENTION

This invention is in the field of computer security; more specifically, the invention comprises a method of working with encryption in a program- and method-agnostic way that enables maximal control over who can view and store data at arbitrary steps of data processing.

### BACKGROUND OF THE INVENTION

Traditional encryption involves a key shared between the sender and recipient of a document (or other data), or a public key promulgated by the recipient and used by the sender. To encrypt data destined for a category of recipients, the sender must separately encrypt the document to each recipient. Once encrypted and transmitted, the sender retains no control over how the data, once received, may be used. This allows recipients to use data beyond the authority intended by the sender, e.g., absconding with the data.

### BRIEF DESCRIPTION OF THE DRAWINGS

FIG. 1 illustrates an example framework for the invention.

FIG. 2 illustrates an example method for the invention.

FIGS. 3A-3B illustrate an example use of encryption across multiple domains.

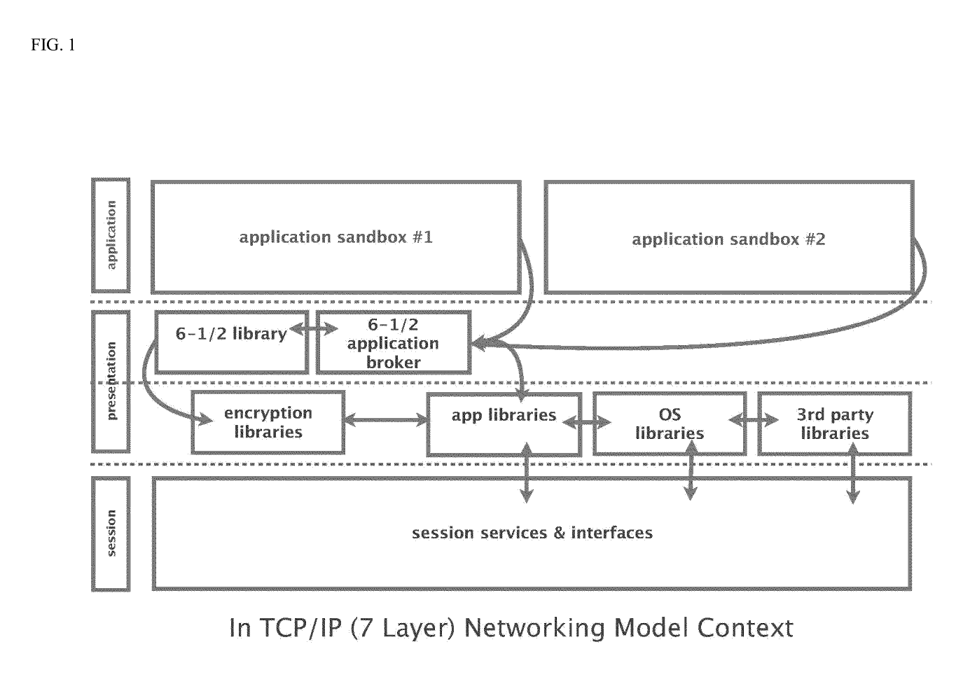

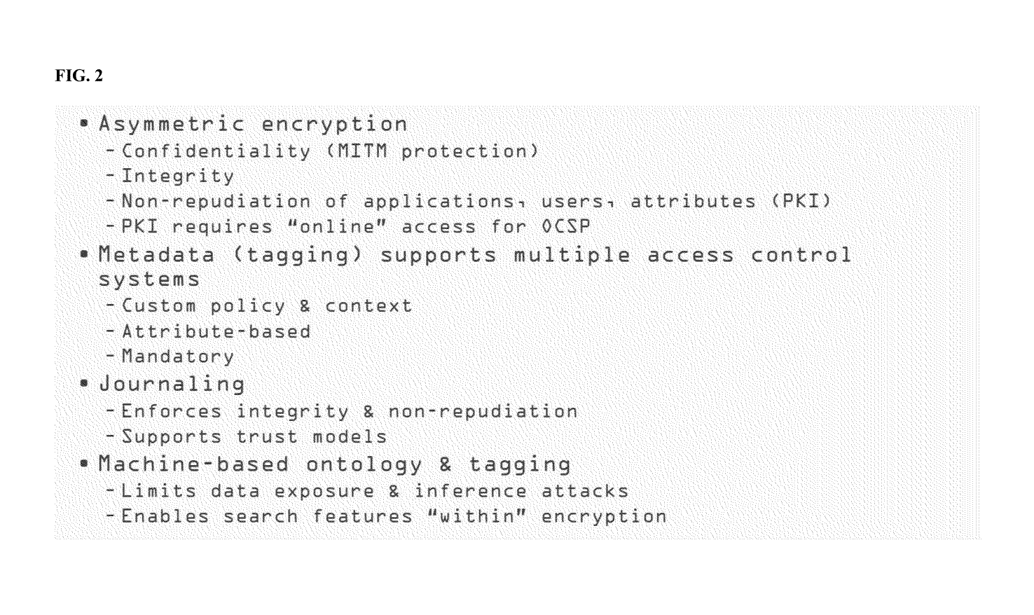

### BRIEF SUMMARY OF THE PRESENT INVENTION

With the invention, rather than the sender encrypting the data directly to the key of the intended recipient, the sender instead encrypts the data to a policy decision point (residing, for instance, on a server), and instructs the server as to the policy under which it is to be decrypted (for instance, when someone with certain responsibilities asks for it, when a date has been reached, etc.). A putative recipient, wishing to read the data, makes a request to the policy decision point. If the decryption policy is satisfied, the policy decision point decrypts the data using its key, and re-encrypts the data using a temporary key for the recipient, then sends the data to the recipient. The recipient decrypts the data using the temporary key.

### DETAILED DESCRIPTION OF THE INVENTION

The invention defines a technique by which asymmetric cryptographic key/certificate sets can be generated, managed, and distributed for data confidentiality and integrity in direct correlation with method-agnostic access/data control methodologies (mandatory, role-based, etc.) to extend protected data availability without pre-sharing of cryptographic keys. The defined technique establishes that created keys are temporary and data cryptographically processed must have an external (program, user, etc.) key owner/generator (which may not or may not be programmatically collocated) which maintains a “journal” of data interchanges for all cryptographic key/certificate sets it has generated. These interchanges may be managed via method-agnostic policy implementations, which could be centralized or decentralized, and provides but does not require a centralized “Policy Decision Point” (PDP) which may enable and provide a “combined” access control, data, or other interchange management function whether directly established or delegated.

Furthermore, the invention provides a technique by which existing data interchanges can be strengthened without modifying existing protocols (TCP/UDP, SSL, etc.) via standardizing interchange “order of operations” currently left at the discretion of individual data interchange developers/maintainers which often lead to mis-implementation and/or incompatibility. The invention provides a process by which data owners can integrate cryptographic functions into existing and future decision-making processes of data interchange, access control, data sharing and management, etc., without pre-determined policy by providing “Process Pipes” by which technologies can be integrated, which may not even be directly compatible with each other, at appropriate positions in the invented process. Data interactions failing to follow this process will behave according to their programming/configurations but ultimately will default to policy decisions established at the key providers. The invention provides a method by which developers/maintainers can optionally leverage to provide compatibility with the invention methods via a program agnostic “Presentation Layer 6½ Library” developed for their platform.

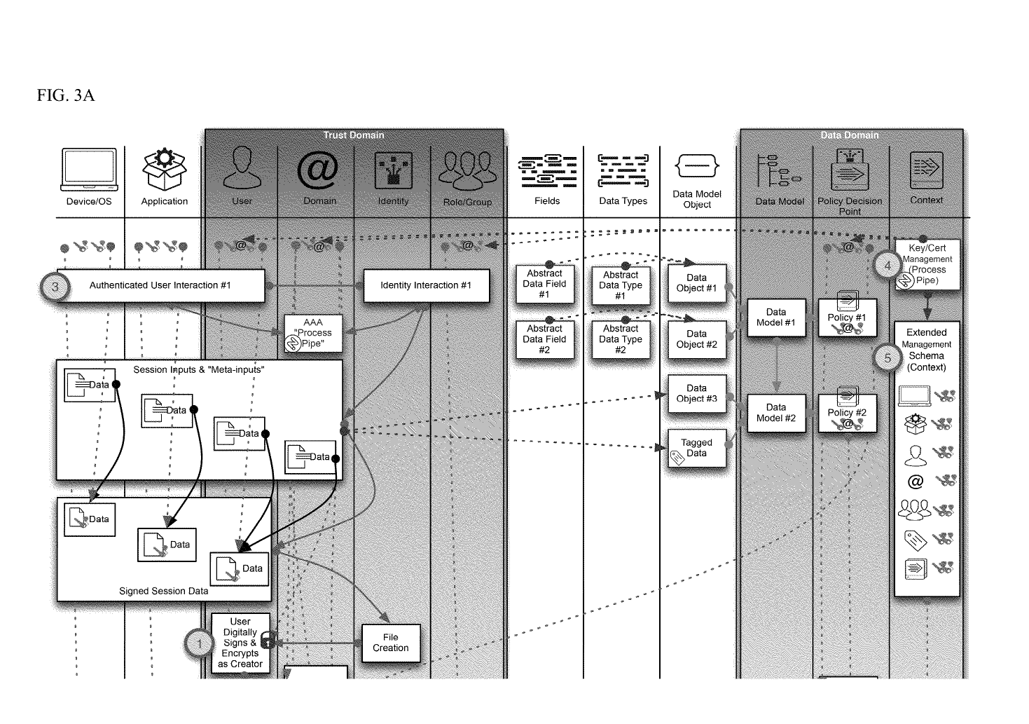

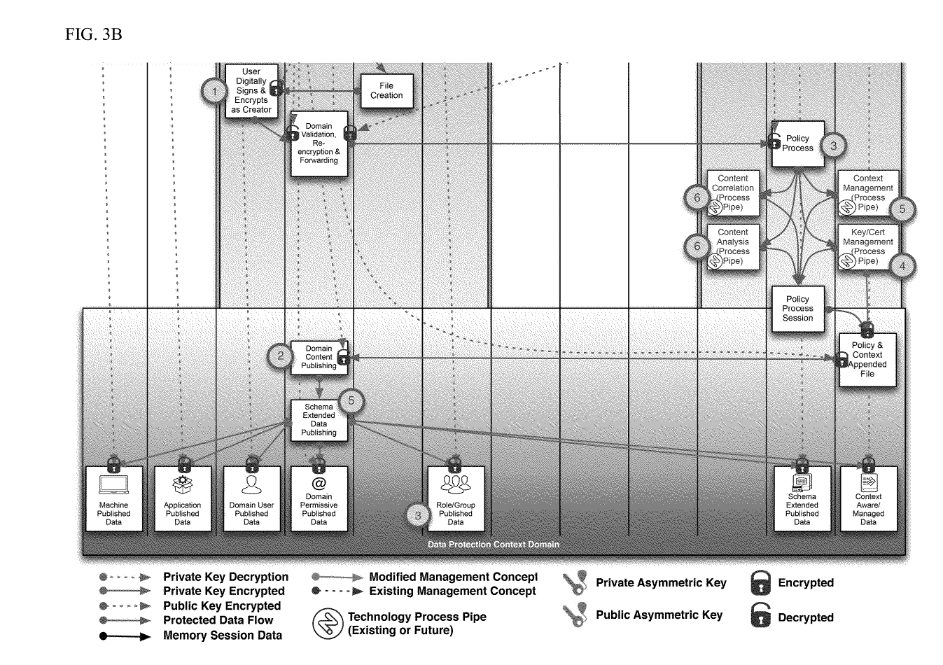

As a non-limiting example, Alice wishes to protect certain data, D, while allowing other persons to access it under particular conditions. Alice constructs a policy, P, detailing the policy under which the document may be accessed. For instance, when persons in a certain role or position request it (e.g., when an attorney for the company requests access), when a certain date or other condition has been achieved (e.g., allow access only after Jan. 1, 2015), or any other condition or combination of conditions. Alice may construct this policy herself, have it provided to her by an organization, or a combination of the two factors. Once the policy P is constructed, Alice encrypts her data D using the key of the Policy Decision Point, PDP, and transmits it, along with P, to the PDP. (FIGS. 3A-3B (1).) The PDP may reside on a server, within a program, or in some other form. The PDP receives encrypted data D and stores it in the encrypted form. (FIGS. 3A-3B (2).)

Bob wishes to access D. He requests access to D by sending a message to the Policy Decision Point, PDP. If the policy P requires it, Bob may identify himself to the PDP by means of a password, passphrase, one-time-password, biometric, or other factors (including intervention by the operator of the PDP, for instance, if the policy P requires human verification of business documents). The PDP then decides if the policy P has been satisfied. If not, it does not grant access to D; it may send an error message to Bob, it may log the error, it may take other actions, or it may do nothing. If the policy P has been satisfied, Bob provides a temporary encryption key to the PDP. The PDP then decrypts D using its encryption key, and re-encrypts D using Bob's temporary encryption key. The PDP then transmits the newly-encrypted D to Bob. The PDP may also take other actions, such as logging, as described above. Bob is then able to utilize D. (FIGS. 3A-3B (3).)

Each time the PDP transmits data, it uses a new temporary encryption key to protect the data while in transit. This means that to access a set of data, D1, D2, D3, and D4, a requestor must have the appropriate decryption key associated with the transmission of that data to that recipient; that is, D1 as transmitted to Bob will not be decryptable by a decryption key held by Charlie, even if both Charlie and Bob have access to D1Similarly, for Bob to access D1, D2, D3, and D4, Bob must have the particular temporary decryption keys associated with the PDP's transmission of those data units to Bob. (FIGS. 3A-3B (4).)

The PDP controls both encryption of data while it is stored at the PDP (“data at rest”) and while it is in transit to a requestor (“data in transit”). (FIGS. 3A-3B (4).) The PDP is responsible for handling the encryption keys used for every (requestor, data) pair, and as such can log all access attempts, provide auditing services, and administer complex data access policies, in a way that is transparent to the end-user and agnostic with regard to what kind of data is being protected, and the type of encryption being used to protect it. (FIGS. 3A-3B (5).) For instance, the PDP can simultaneously protect whole files or combinations of files (e.g., in a compressed multi-document format) or sensitive portions within files (e.g., portions of documents that are restricted to different levels of need-to-know), using different types of encryption, different key lengths, or other differences in security between different data. (FIGS. 3A-3B (6))

The PDP may also be non-unitary. That is, rather than a centralized PDP, a user may run a PDP on the user's personal device, local network, or other distributed location. If Bob requests access to a file in this multilateral PDP scenario, he requests the data D from his local PDP, L-PDP. L-PDP then contacts the responsible PDP, R-PDP, and requests D. If the policy for access, P, stored by R-PDP is met, R-PDP then encrypts the data using the temporary key of L-PDP, and transmits D to L-PDP, along with an access policy L-P. If L-P is met, L-PDP may then decrypt D using its key, re-encrypt it using Bob's temporary key, and transmit D to Bob. This allows for distributed, local control of documents without giving end-users unlimited access. The network of PDPs may be extended and organized in any way, such as a hierarchical organization, a web, or different co-equal responsible parties for different types of data. The network of distributed PDPs may be extended arbitrarily. In some scenarios, the data policy P may specify what types of L-PDPs it will allow to request the data from its original PDP, and the local access policy L-P may be the same or more restrictive than the original access policy P.

### System Implementation

The systems and methods described herein can be implemented in software, hardware, or any combination thereof. The systems and methods described herein can be implemented using one or more computing devices, which may or may not be physically or logically separate from each other. Additionally, various aspects of the methods described herein may be combined or merged into other functions.

In some embodiments, the system elements could be combined into a single hardware device or separated into multiple hardware devices. If multiple hardware devices are used, the hardware devices could be physically located proximate to or remotely from each other.

The methods can be implemented in a computer program product accessible from a computer-usable or computer-readable storage medium that provides program code for use by or in connection with a computer or any instruction execution system. A computer-usable or computer-readable storage medium can be any apparatus that can contain or store the program for use by or in connection with the computer or instruction execution system, apparatus, or device.

A data processing system suitable for storing and/or executing the corresponding program code can include at least one processor coupled directly or indirectly to computerized data storage devices such as memory elements. Input/output (I/O) devices (including but not limited to keyboards, displays, pointing devices, etc.) can be coupled to the system. Network adapters may also be coupled to the system to enable the data processing system to become coupled to other data processing systems or remote printers or storage devices through intervening private or public networks. To provide for interaction with a user, the features can be implemented on a computer with a display device, such as an LCD (liquid crystal display), or another type of monitor for displaying information to the user, a keyboard, and an input device, such as a mouse or trackball by which the user can provide input to the computer.

A computer program can be a set of instructions that can be used, directly or indirectly, in a computer. The systems and methods described herein can be implemented using programming and/or markup languages such as Perl, Python, JAVA™, C++, C, C#, Visual Basic™, JavaScript™, PHP, Flash™, XML, HTML, etc., or a combination of programming and/or markup languages, including compiled or interpreted languages, and can be deployed in any form, including as a stand-alone program or as a module, component, subroutine, or other unit suitable for use in a computing environment. The software can include, but is not limited to, firmware, resident software, microcode, etc. Protocols and standards such as SOAP/HTTP, JSON, SQL, etc. may be used in implementing interfaces between programming modules. The components and functionality described herein may be implemented on any desktop or server operating system executing in a virtualized or non-virtualized environment, using any programming language suitable for software development, including, but not limited to, different versions of Microsoft™ Windows™, Apple™ Mac™, iOS™, Unix™/X-Windows™, Linux™, etc.

In some embodiments, one or more servers can function as a file server and/or can include one or more of the files used to implement methods of the invention incorporated by an application running on a user computer and/or another server. Alternatively, a file server can include some or all necessary files, allowing such an application to be invoked remotely by a user computer and/or server. The functions described with respect to various servers herein (e.g., application server, database server, web server, file server, etc.) can be performed by a single server and/or a plurality of specialized servers, depending on implementation-specific needs and parameters.

In some embodiments, the system can include one or more databases. The location of the database(s) is discretionary. As non-limiting examples, a database might reside on a storage medium local to (and/or resident in) a server (and/or a user computer). Alternatively, a database can be remote from any or all of the computing devices, so long as it can be in communication (e.g., via a network) with one or more of these. In some embodiments, a database can reside in a storage area network (SAN). The SAN can be implemented as a computerized data storage device group. Some or all of the necessary files for performing the functions attributed to the computers can be stored locally on the respective computer and/or remotely, as appropriate. In some embodiments, the database can be a relational database, such as an Oracle database, that is adapted to store, update, and retrieve data in response to SQL-formatted commands. The database can be controlled and/or maintained by a database server.

Suitable processors for the execution of a program of instructions include, but are not limited to, general and special purpose microprocessors, and the sole processor or one of multiple processors or cores, of any kind of computer. A processor may receive and store instructions and data from a computerized data storage device such as a read-only memory, a random access memory, both, or any combination of the data storage devices described herein. A processor may include any processing circuitry or control circuitry operative to control the operations and performance of an electronic device.

The processor may also include, or be operatively coupled to communicate with, one or more data storage devices for storing data. Such data storage devices can include, as non-limiting examples, magnetic disks (including internal hard disks and removable disks), magneto-optical disks, optical disks, read-only memory, random access memory, and/or flash storage. Storage devices suitable for tangibly embodying computer program instructions and data can also include all forms of non-volatile memory, including, for example, semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The systems, modules, and methods described herein can be implemented using any combination of software or hardware elements. The systems, modules, and methods described herein can be implemented using one or more virtual machines operating alone or in combination with each other. Any applicable virtualization solution can be used for encapsulating a physical computing machine platform into a virtual machine that is executed under the control of virtualization software running on a hardware computing platform or host. The virtual machine can have both virtual system hardware and guest operating system software.

The systems and methods described herein can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, but are not limited to, a LAN, a WAN, or any of the networks that form the Internet.

One or more embodiments of the invention may be practiced with other computer system configurations, including hand-held devices, microprocessor systems, microprocessor-based or programmable consumer electronics, minicomputers, mainframe computers, etc. The invention may also be practiced in distributed computing environments where tasks are performed by remote processing devices that are linked through a network.

While one or more embodiments of the invention have been described, various alterations, additions, permutations, and equivalents thereof are included within the scope of the invention.

1. A computerized method for encrypting data, the method comprising:
a sender encrypts data to a policy decision point residing on a server;
instructing the server as to a policy under which the data is to be decrypted;
receiving a request to read the data from a putative recipient at a policy decision point;
if a decryption policy is satisfied:
the policy decision point decrypts the data using its key;
the policy decision point re-encrypts the data using a temporary key for the recipient;
the policy decision point then sends the data to the recipient; and
the recipient decrypts the data using the temporary key.
